(19) United States
(12) Patent Application Publication
(10) Pub. No.: US 2021/0095129 A1
(43) Pub. Date: Apr. 1, 2021

(54) THERMAL INDICATOR, THERMAL INDICATING COMPOSITION AND THERMAL INDICATING STRUCTURE

(71) Applicant: 3M INNOVATIVE PROPERTIES COMPANY, St Paul, MN (US)

(72) Inventors: Ying Lin, Woodbury, MN (US); Hassan Sahouani, Hastings, MN (US); Ying Shi, Shanghai (CN); Kenneth M. White, Oakdale, MN (US)

(21) Appl. No.: 16/498,804

(22) PCT Filed: Mar. 29, 2017
(86) PCT No.: PCT/CN2017/078580

§ 371 Date: Sep. 27, 2019

(51) Int. Cl. C09B 67/20; C09J 11/06; C09J 7/24; C09J 7/25; C09J 7/29; G01K 11/06; G01K 11/12

(52) U.S. Cl. CPC C09B 67/0063; C09J 2301/122; C09J 7/24; C09J 7/25; C09J 7/29; G01K 11/06; G01K 11/12; C09J 2461/006; C09J 2425/006; C09J 2433/006; C09J 2491/001; C09J 2423/041; C09J 2475/001; C09J 2301/41; C09J 2301/162; C09J 11/06

(57) ABSTRACT

A thermal indicator, a thermal indicating composition (1), as well as two kinds of thermal indicating structures (11) are disclosed. The thermal indicator comprises an organic solid material (2) having a melting point higher than ambient temperature and a dye (3) which contacts the organic solid material (2) and is capable of being dissolved in the organic solid material (2) when the thermal indicator is heated to the melting point of the organic solid material (2). The thermal indicator, the thermal indicating composition (1), as well as these two kinds of thermal indicating structures (1) have simple structures and can be manufactured by a simple process. Furthermore, the existence of the dye (3) in its crystalline state offers significant resistance to UV radiation in outdoor applications.

### FIELD OF THE INVENTION

This invention relates to the technical field of thermal indication for electrical products, and particularly to a thermal indicator, a thermal indicating composition, as well as two kinds of thermal indicating structures.

### BACKGROUND OF THE INVENTION

Thermal indicators are known in the art. Specifically, a thermal indicator (for example, a temperature sensor label) is capable of being affixed easily to a desired part of various types of electrical apparatus and being used in a small space without the need of a power source or the like. For these reasons, such temperature sensor labels are widely used in all kinds of industries to regulate the temperature of the electrical apparatus. The temperature sensor labels are of an irreversible type and a reversible type. The irreversible temperature sensor label changes color to indicate the fact that the temperature of a measured object has reached or overrun a preset level, and continues the same color indication even after the temperature of the measured object has decreased back to the set level or lower. The reversible temperature sensor label changes the color indication in response to the change in the temperature of the measured object. The irreversible temperature sensor label is used widely, for example, for the temperature regulation of remotely located and unmanned electrical apparatus or apparatus needing to be regularly checked at fixed intervals. There are various types of coloring mechanism for the irreversible thermal indicators. A number of them rely on a chemical reaction that takes place at a given temperature. Others take advantage of optical principles such as diffusive effects of some compounds such as waxes to expose a permanent color in the background (for example, see, U.S. Pat. No. 7,063,041B2).

It is still desired in the field to develop a thermal indicator which may be manufactured in a simple process and has long durability.

### SUMMARY OF THE INVENTION

The invention aims to overcome the shortcomings in the prior art, and specifically, provides a thermal indicator, a thermal indicating composition, as well as two kinds of thermal indicating structures.

According to the first aspect of the invention, there provides a thermal indicator comprising an organic solid material having a melting point higher than ambient temperature and a dye which contacts the organic solid material and is capable of being dissolved in the organic solid material when the thermal indicator is heated to the melting point of the organic solid material.

According to the second aspect of the invention, there provides a thermal indicating composition comprising 5 to 95% by weight of an organic solid powder having a melting point higher than ambient temperature, and 0.01 to 5% by weight of a dye which is capable of being dissolved in the organic solid powder when the thermal indicating composition is heated to the melting point of the organic solid powder, based on the total weight of the thermal indicating composition.

According to the third aspect of the invention, there provides a thermal indicating structure comprising a transparent substrate, an adhesive layer, and a stripping liner laminated in turn, wherein one side of the transparent substrate facing to the adhesive layer has one or more depression portions which are filled with the thermal indicating composition as described above.

According to the fourth aspect of the invention, there provides a thermal indicating structure comprising a transparent substrate, an organic solid layer having a melting point higher than ambient temperature, a dye layer, an isolation polymer layer, an adhesive layer, and a stripping liner laminated in turn, wherein the dye layer comprises a dye which is capable of being dissolved in the organic solid layer when the thermal indicating structure is heated to the melting point of the organic solid layer.

According to the technical solution of the invention, the thermal indicator, the thermal indicating composition, as well as these two kinds of thermal indicating structures have simple structures and can be manufactured by a simple process. Furthermore, the existence of the dye in its crystalline state offers significant resistance to UV radiation in outdoor applications.

### BRIEF DESCRIPTION OF THE DRAWINGS

In order to illustrate the technical solutions in embodiments of the invention or in the prior art more clearly, figures required for describing the embodiments will be simply introduced below. It is apparent that the figures described below are merely some embodiments of the invention, and other figures may be further obtained by those of ordinary skill in the art according to these figures without exerting inventive work.

FIG. 1 shows a schematic view for the color change mechanism of a thermal indicating composition upon heating according to an embodiment of the invention;

FIG. 2 shows a schematic structure of the cross section of a thermal indicating structure comprising a thermal indicating composition according to the third aspect of the invention; and

FIG. 3 shows a schematic structure of the cross section of a thermal indicating structure comprising a thermal indicating composition according to the fourth aspect of the invention.

FIG. 4 shows a modified form of the thermal indicating structure comprising a thermal indicating composition according to the fourth aspect of the invention.

### REFERENCE NUMERALS

1—Thermal indicating composition;
2—Organic solid powder;
3—Dye (in the form of dye clusters or dye crystals);
4—Dye (in the form of single molecules);
5, 11—Thermal indicating structure;
6, 12—Transparent substrate;
7, 16—Adhesive layer;
8, 17—Stripping liner;
9—Depression portion;
10, 15—Isolation polymer layer;
13—Organic solid layer;
14—Dye layer; and
18—rising portion.

### DETAILED DESCRIPTION OF THE INVENTION

The technical solutions in the embodiments of the invention will be described clearly and fully below in conjunction with accompanying drawings in embodiments of the invention. Obviously, the embodiments described are merely part of the embodiments of the invention, rather than all of the embodiments. Based on the embodiments in the invention, all other embodiments obtained by those of ordinary skill in the art without performing inventive work belong to the scope protected by the invention.

In the present invention, unless indicated otherwise, the term “ambient temperature” has the corresponding meaning commonly used in the field, and specifically, “ambient temperature” refers to a temperature between 15° C. and 25° C.

A thermal indicator is a solid material capable of changing color when it is exposed to a predetermined temperature higher than a predetermined normal working temperature. One of the primary features of this invention takes advantage of the difference in color between the crystalline state and molecular state of a given dye. According to the technical solution of the invention, a specific organic solid material having a melting point higher than ambient temperature is used as a latent solvent for dissolving the dye and showing the inherent color thereof so as to achieve the technical effect of thermal indication. Being latent, the specific organic solid material does not act on the dye until it is melted. The specific organic solid material and the dye are fabricated into a stable construction which may be specifically selected according to different applications. When the construction is heated to the melting temperature of the organic solid material, the organic solid material becomes a solvent for the dye which then dissolves and shows the true color thereof in its molecular state. The dye may exist in the construction in the form of an extremely thin layer, dye clusters (that is, a dye powder), or dye crystals, as long as this dye does not show its color when it is checked by naked eyes because it is not dissolved in the solid material and is too tiny to be observed. However, when the dye exists in its crystalline state in this stable construction, the crystalline form of the dye offers significant resistance to UV radiation in outdoor applications.

Specifically, according to the first aspect of the invention, there provides a thermal indicator comprising an organic solid material having a melting point higher than ambient temperature and a dye which contacts the organic solid material and is capable of being dissolved in the organic solid material when the thermal indicator is heated to the melting point of the organic solid material.

According to the invention, the organic solid material has a melting point higher than ambient temperature (a temperature between 15° C. and 25° C.).

According to some embodiments of the invention, the melting point of the organic solid material is preferably between 70° C. and 130° C., more preferably between 85° C. and 95° C., and most preferably between 80° C. and 90° C.

The organic solid material is colorless, white or pale yellow. Preferably, the organic solid material is colorless so that the dye may show its true color directly after dissolving into the organic solid material which has been heated to its melting point.

There is no specific limitation about the particular material of the organic solid material, as long as it may melt and dissolve the dye as a latent solvent when this organic solid material is heated to its melting point. According to some embodiments of the invention, the organic solid material is selected from a wax, a polymer, an organic non-polymeric material, or a mixture thereof. According to some embodiments of the invention, the organic non-polymeric material is a molecular compound, such as vanillin or triphenylphosphine. One example of the commercially available vanillin is Vanillin (4-Hydroxy-3-methoxybenzaldehyde whose melting point is 81-83° C.) from Alfa Aesar. According to some embodiments of the invention, the wax is selected from castor wax, carnauba wax, a synthetic wax, or a mixture thereof. An example of the commercially available castor wax is Hydrogenated Castor Oil (CAS #: 8001-78-3) from Jedwards International, Inc., whose melting point is between 80° C. and 87° C. An example of the commercially available carnauba wax is Carnauba wax (a natural wax consists of aliphatic esters whose melting point is between 83° C. and 90° C.; CAS: 8015-86-9) from Koster Keunen. An example of the commercially available synthetic wax is Synwax A-90 from Koster Keunen whose melting point is between 85° C. and 90° C. There is no specific limitation about the above polymer having a melting point higher than ambient temperature, as long as it may melt and dissolve the dye as a latent solvent when this organic solid material is heated to its melting point. According to some embodiments of the invention, the polymer is selected from polyethylene, polyurethane, other low melting temperature polymers, or a mixture thereof.

There is no specific limitation about the particular material of the dye, as long as it may dissolve in the organic solid material when this organic solid material is heated to its melting point. According to some embodiments of the invention, the dye is selected from an anthraquinone dye, an amino ketone dye, a solvent dye, or a mixture thereof. An example of the commercially available anthraquinone dye is Solvent Orange 63 (CAS:16294-75-0) from WinChem Industrial Co. An example of the commercially available amino ketone dye is Solvent Yellow 98 (CAS:12671-74-8/27870-92-4) from WinChem Industrial Co. Another example of the commercially available solvent dye is Pylakrome Magenta LX-11527 from Pylam Chemical Corporation.

As mentioned above, the specific organic solid material and the dye are fabricated into a stable construction which may be specifically selected according to different applications. When the construction is heated to the melting temperature of the organic solid material, the organic solid material becomes a solvent for the dye which then dissolves and shows the true color thereof in its molecular state. The dye may exist in the construction in the form of an extremely thin layer, dye clusters (a dye powder), or dye crystals, as long as this dye does not show its true color when it is checked by naked eyes because it is not dissolved in the solid material and is too tiny to be observed. However, when the dye exists in its crystalline state in this stable construction, the crystalline form of the dye offers significant resistance to UV radiation in outdoor applications.

According to the second aspect of the invention, there provides a thermal indicating composition comprising 5 to 95% by weight of an organic solid powder having a melting point higher than ambient temperature, and 0.01 to 5% by weight of a dye which is capable of being dissolved in the organic solid powder when the thermal indicating composition is heated to the melting point of the organic solid powder, based on the total weight of the thermal indicating composition.

According to the invention, the organic solid powder has a melting point higher than ambient temperature (a temperature between 15° C. and 25° C.).

According to some embodiments of the invention, the melting point of the organic solid powder is preferably between 70° C. and 130° C., more preferably between 85° C. and 95° C., and most preferably between 80° C. and 90° C.

The organic solid powder is colorless, white or pale yellow. Preferably, the organic solid powder is colorless so that the dye may show its true color directly after dissolving into the organic solid powder which has been heated to its melting point.

There is no specific limitation about the particular material of the organic solid powder, as long as it may melt and dissolve the dye as a latent solvent when this organic solid powder is heated to its melting point. According to some embodiments of the invention, the organic solid powder is selected from a wax, a polymer, an organic non-polymeric material, or a mixture thereof. According to some embodiments of the invention, the organic non-polymeric material is a molecular compound, such as vanillin and triphenylphosphine. One example of the commercially available vanillin is Vanillin (4-Hydroxy-3-methoxybenzaldehyde whose melting point is 81-83° C.) from Alfa Aesar. According to some embodiments of the invention, the wax is selected from castor wax, carnauba wax, a synthetic wax, or a mixture thereof. An example of the commercially available castor wax is Hydrogenated Castor Oil (CAS #: 8001-78-3) from Jedwards International, Inc., whose melting point is between 80° C. and 87° C. An example of the commercially available carnauba wax is Carnauba wax (a natural wax consists of aliphatic esters whose melting point is between 83° C. and 90° C.; CAS: 8015-86-9) from Koster Keunen. An example of the commercially available synthetic wax is synwax A-90 from Koster Keunen whose melting point is between 85° C. and 90° C. There is no specific limitation about the above polymer having a melting point higher than ambient temperature, as long as it may melt and dissolve the dye as a latent solvent when this organic solid material is heated to its melting point. According to some embodiments of the invention, the polymer is selected from polyethylene, polyurethane, other low melting temperature polymers, or a mixture thereof.

There is no specific limitation about the particular material of the dye, as long as it may dissolve in the organic solid material when this organic solid material is heated to its melting point. According to some embodiments of the invention, the dye is selected from an anthraquinone dye, an amino ketone dye, a solvent dye, or a mixture thereof. An example of the commercially available anthraquinone dye is Solvent Orange 63 (CAS:16294-75-0) from WinChem Industrial Co. An example of the commercially available amino ketone dye is Solvent Yellow 98 (CAS:12671-74-8/27870-92-4) from WinChem Industrial Co. An example of the commercially available solvent dye is Pylakrome Magenta LX-11527 from Pylam Co.

As mentioned above, the specific organic solid powder and the dye are mixed together with other optional components to form a stable thermal indicating composition. When the composition is heated to the melting temperature of the organic solid powder, the organic solid powder melts and becomes a solvent for the dye which then dissolves and shows the true color thereof in its molecular state. The dye may exist in the composition in the form of dye clusters (a dye powder), or dye crystals, as long as this dye does not show its true color when it is checked by naked eyes because it is not dissolved in the solid powder and is too tiny to be observed. However, when the dye exists in its crystalline state in this stable composition, the crystalline form of the dye offers significant resistance to UV radiation in outdoor applications.

According to some embodiments of the invention, the organic solid powder has an average particle size of 1 μm to 100 preferably 1 μm to 50 μm, and more preferably 1 μm to 20 μm.

According to some embodiments of the invention, the thermal indicating composition further comprises a binder. The binder is used to bind the specific organic solid powder, the dye and other optional components together to form a stable thermal indicating composition. According to some embodiments of the invention, the binder is selected from a butylmethacrylate/isobutylmethacrylate copolymer, a dispersion of phenoxy resin, a styrene-isoprene-styrene triblock copolymer, a polystyrene-acrylic emulsion, or a mixture thereof. An example of the commercially available butylmethacrylate/isobutylmethacrylate copolymer is from Scientific Polymer Products, Inc. (CAS: 9011-53-4; a 50/50 copolymer having a weight average molecular weight of 200K). The examples of the commercially available phenoxy resin are PKHW-35 and PKHW-34, which are waterborne colloidal dispersions of high molecular weight Phenoxy resin from Gabriel Chemicals. An example of the commercially available styrene-isoprene-styrene triblock copolymer is Kraton D1161, which is a linear triblock copolymer based on styrene and isoprene, from Kraton Polymer. The examples of the commercially available polystyrene-acrylic emulsion are Rovene 6025 and Rovene 6066 which are 50 wt % solid Latex dispersions from Mallard Creek Polymers, Inc.

According to some embodiments of the invention, in order to improve the resistance to UV radiation, the thermal indicating composition further comprises an ultraviolet stabilizer. According to some embodiments of the invention, the thermal indicating composition comprises 0.1 to 5% by weight of an ultraviolet stabilizer. The ultraviolet stabilizer is selected from decanedioic acid (for example, Tinuvin 123 DW from BASF), bis(2,2,6,6-tetramethyl-1-(octyloxy)-4-piperidinyl)ester, 2-hydroxy-phenyl-s-triazine (for example, Tinuvin 400 DW from BASF), or a mixture thereof.

According to some embodiments of the invention, in order to improve the oxidative stability, the thermal indicating composition further comprises an antioxidant. According to some embodiments of the invention, the thermal indicating composition comprises 0.05 to 2.5% by weight of an antioxidant. An example of the commercially available antioxidant is pentaerythritol tetrakis(3-(3,5-di-tert-butyl-4-hydroxyphenyl)propionate) (for example, Irganox 1010 from BASF).

According to some embodiments of the invention, in order to improve the developing ability, the thermal indicating composition further comprises a brightening agent. According to some embodiments of the invention, the thermal indicating composition comprises 0.1 to 5% by weight of a brightening agent. The brightening agent is preferably titanium dioxide.

According to some embodiments of the invention, in order to improve the rheological characteristic of the composition, the thermal indicating composition further comprises a rheology modifier. According to some embodiments of the invention, the thermal indicating composition comprises 1 to 10% by weight of a rheology modifier. The rheology modifier is selected from polyvinyl alcohol, polyacrylic acid, hyroxypropyl methyl cellulose, carboxymethyl cellulose, polysaccharides, or a mixture thereof.

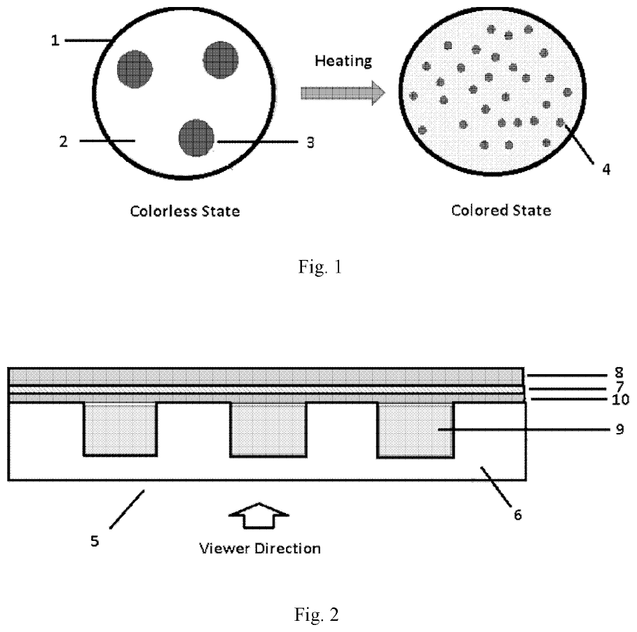

FIG. 1 shows a schematic view for the color change mechanism of a thermal indicating composition upon heating according to an embodiment of the invention. As shown in FIG. 1, the thermal indicating composition 1 comprises organic solid powders 2 which form a continuous phase, and dye particles 3 which are dispersed in a form of dye clusters or dye crystals in the continuous phase of the organic solid powder 2. When the thermal indicating composition 1 is heated to the melting point of the organic solid powder 2, the organic solid powder 2 melts and the dye particles 3 dissolve as single molecules in the melt solid solvent to show the true color of the dye 4.

According to the third aspect of the invention, there provides a thermal indicating structure comprising a transparent substrate, an adhesive layer, and a stripping liner laminated in turn, wherein one side of the transparent substrate facing to the adhesive layer has one or more depression portions which are filled with the thermal indicating composition as described above.

According to the invention, the depression portion is provided to accommodate the thermal indicating composition so that the thermal indicating composition is sandwiched between the transparent substrate and the adhesive layer. According to some embodiments of the invention, the depression portions are cavities having an average size of 0.1 to 0.5 cm, preferably 0.1 to 0.25 cm, and more preferably, 0.1 to 0.15 cm. Specifically, the depression portions are grooves having a width of at least 2 microns, a depth of at least 2 microns, and a length extending the length of the transparent substrate. Preferably, the grooves are parallel grooves. According to some embodiments of the invention, the thermal indicating structure of the invention further comprises an isolation polymer layer immediately adjacent to the adhesive layer, that is, between the adhesive layer and the depression portions which are filled with the thermal indicating composition. The function of this isolation polymer layer is to prevent the dye in the depression portions from dissolving in the adhesive layer.

FIG. 2 shows a schematic structure of the cross section of a thermal indicating structure comprising a thermal indicating composition according to the third aspect of the invention. Specifically, a thermal indicating structure 5 comprises a transparent substrate 6, an adhesive layer 7, and a stripping liner 8 laminated in turn, wherein one side of the transparent substrate 6 facing to the adhesive layer 7 has one or more depression portions 9 which are filled with the thermal indicating composition as described above. The thermal indicating structure 5 further comprises an isolation polymer layer 10 immediately adjacent to the adhesive layer 7, that is, between the adhesive layer 7 and the depression portions 9 which are filled with the thermal indicating composition. The function of this isolation polymer layer 10 is to prevent the dye in the depression portions 9 from being dissolved in the adhesive layer 7. The material for the isolation polymer layer 10 may be selected properly by those skilled in the art, as long as the technical effect thereof is achieved. Optionally, in an alternative embodiment, the transparent substrate 6 can comprise a UV resistant material that blocks the transmission of UV light. In this alternative embodiment, the transparent substrate 6 can comprise one or several dispersed UV absorbers such as 2-hydroxyphenyl-benzophenone (BP), 2-(2-hydroxyphenyl)-benzotriazole (BTZ) or 2-hydroxyphenyl-s-triazine (HPT) available from BASF and an antioxidant such as sterically hindered phenols, sterically hindered amines, phosphites or thioethers also available from BASF. In a further alternative embodiment, at least one major surface of the transparent substrate 6, such as the surface facing the viewer, can be coated with a UV blocking film, such as Sun Control Prestige film, available from 3M Company.

According to the fourth aspect of the invention, there provides a thermal indicating structure comprising a transparent substrate, an organic solid layer having a melting point higher than ambient temperature, a dye layer, an isolation polymer layer, an adhesive layer, and a stripping liner laminated in turn, wherein the dye layer comprises a dye which is capable of being dissolved in the organic solid layer when the thermal indicating structure is heated to the melting point of the organic solid layer.

According to the invention, the organic solid layer has a melting point higher than ambient temperature (a temperature between 15° C. and 25° C.).

According to some embodiments of the invention, the melting point of the organic solid layer is preferably between 70° C. and 130° C., more preferably between 85° C. and 95° C., and most preferably between 80° C. and 90° C.

The organic solid layer is colorless, white or pale yellow. Preferably, the organic solid layer is colorless so that the dye may show its true color directly after dissolving into the organic solid material in the organic solid layer which has been heated to its melting point.

There is no specific limitation about the particular material of the organic solid layer, as long as it may melt and dissolve the dye as a latent solvent when this organic solid layer is heated to its melting point. According to some embodiments of the invention, the organic solid layer is formed of a wax, a polymer, an organic non-polymeric material, or a mixture thereof. According to some embodiments of the invention, the organic non-polymeric material is a molecular compound, such as vanillin and triphenylphosphine. One example of the commercially available vanillin is Vanillin (4-Hydroxy-3-methoxybenzaldehyde whose melting point is 81-83° C.) from Alfa Aesar. According to some embodiments of the invention, the wax is selected from castor wax, carnauba wax, a synthetic wax, or a mixture thereof. An example of the commercially available castor wax is Hydrogenated Castor Oil (CAS #: 8001-78-3) from Jedwards International, Inc., whose melting point is between 80° C. and 87° C. An example of the commercially available carnauba wax is Carnauba wax (a natural wax consists of aliphatic esters whose melting point is between 83° C. and 90° C.; CAS: 8015-86-9) from Koster Keunen. An example of the commercially available synthetic wax is synwax A-90 from Koster Keunen whose melting point is between 85° C. and 90° C. There is no specific limitation about the above polymer having a melting point higher than ambient temperature, as long as it may melt and dissolve the dye as a latent solvent when this organic solid material is heated to its melting point. According to some embodiments of the invention, the polymer is selected from polyethylene, polyurethane, other low melting temperature polymers, or a mixture thereof.

There is no specific limitation about the particular material of the dye, as long as it may dissolve in the organic solid layer when this organic solid layer is heated to its melting point. According to some embodiments of the invention, the dye is selected from an anthraquinone dye, an amino ketone dye, a solvent dye, or a mixture thereof. An example of the commercially available anthraquinone dye is Solvent Orange 63 (CAS:16294-75-0) from WinChem Industrial Co. An example of the commercially available amino ketone dye is Solvent Yellow 98 (CAS:12671-74-8/27870-92-4) from WinChem Industrial Co. An example of the commercially available solvent dye is Pylakrome Magenta LX-11527 from Pylam Co.

As mentioned above, the specific organic solid layer and the dye layer are fabricated into a stable construction. When the construction is heated to the melting temperature of the organic solid layer, the organic solid layer becomes a solvent for the dye which then dissolves and shows the true color thereof in its molecular state. The dye may exist in the construction in the form of an extremely thin layer, as long as this dye does not show its true color when it is checked by naked eyes because it is not dissolved in the solid material and is too tiny to be observed. However, when the dye exists in its crystalline state in this stable construction, the crystalline form of the dye offers significant resistance to UV radiation in outdoor applications.

According to some embodiments of the invention, the organic solid layer has a thickness of at least 1 μm, preferably at least 10 μm, and more preferably at least 25 μm. Additionally, according to some embodiments of the invention, the dye layer has a thickness of at least 0.1 μm, preferably at least 0.3 μm, and more preferably at least 0.5 μm. When the thickness of the organic solid layer and the thickness of the dye layer are within the scopes as described above, effective color changing may be observed when the thermal indicating structure according to the fourth aspect of the invention is heated to the melting point of the organic solid layer.

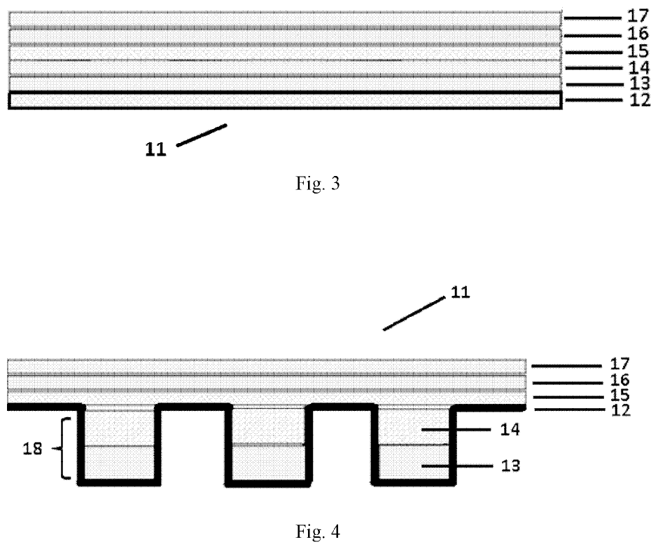

FIG. 3 shows a schematic structure of the cross section of a thermal indicating structure comprising a thermal indicating composition according to the fourth aspect of the invention. Specifically, a thermal indicating structure 11 comprises a transparent substrate 12, an organic solid layer 13 having a melting point higher than ambient temperature, a dye layer 14, an isolation polymer layer 15, an adhesive layer 16, and a stripping liner 17 laminated in turn, wherein the dye layer 14 comprises a dye which is capable of being dissolved in the organic solid layer 13 when the thermal indicating structure 11 is heated to the melting point of the organic solid layer 13. Optionally, in an alternative embodiment, the transparent substrate 12 can comprise a UV resistant material that blocks the transmission of UV light. In this alternative embodiment, the transparent substrate 6 can comprise one or several dispersed UV absorbers such as 2-hydroxyphenyl-benzophenone (BP), 2-(2-hydroxyphenyl)-benzotriazole (BTZ) or 2-hydroxyphenyl-s-triazine (HPT) available from BASF and an antioxidant such as sterically hindered phenols, sterically hindered amines, phosphites or thioethers also available from BASF. In a further alternative embodiment, at least one major surface of the transparent substrate 12, such as the surface facing the viewer, can be coated with a UV blocking film, such as Sun Control Prestige film, available from 3M Company.

According to the cross section of a thermal indicating structure shown in FIG. 3, as a modified form of the thermal indicating structure according to the fourth aspect as shown in FIG. 4, the transparent substrate 12 is structured to have one or more rising portions 18 which accommodate the organic solid layer 13 and the dye layer 14. In this manner, the dye layer can be well prevented from contacting the open air and better color changing may be observed when the thermal indicating structure is heated to the melting point of the organic solid layer.

### EXAMPLES

In order to further illustrate this invention, the detailed description will be made in conjunction with the Examples below.

In the examples, different thermal indicating compositions were prepared according to the methods described in the application and subjected to further tests for estimating the properties of these compositions according to the testing methods described below.

### Testing Methods

### 1. Color Changing Test

A sample of the thermal indicating compositions prepared according to the following examples was coated on a 2″×5″aluminum plate or a PET web. After drying at 70° C. for 5 minutes, the coated aluminum plate or coated PET web was placed into an oven and heated at 85° C. for 10 minutes. Then, the color changing of the thermal indicating composition on the aluminum plate or PET web was checked by naked eyes.

2. UV aging test

A sample of the thermal indicating compositions prepared according to the following examples was coated on a 2″×5″aluminum plate or a PET web. After drying at 70° C. for 5 minutes, the coated aluminum plate was placed into a UV chamber and kept at 70° C. and 1.55 W/s for several days. Then, the color changing of the thermal indicating composition on the aluminum plate or PET web was checked by naked eyes.

### 3. Weathering Test

A sample of the thermal indicating composition prepared according to the following example 7 was exposed to accelerated laboratory weathering in order to demonstrate that it is still “activate” when exposed to high temperature after having been in the out-of-doors for an extended period of time.

Specifically, a sample of the thermal indicating compositions prepared according to the following example 7 was coated on a 2″×5″aluminum plate. After drying at 70° C. for 5 minutes, the coated aluminum plate was subjected to WRC Weathering Method 3-11 for 500, 1002, 1509, or 2015 h.

In WRC Weathering Method 3-11, the sample was exposed to a solar-like irradiance at 2× to 3× the level of peak sunlight at 50-60° C. for at least 500 hours. No water spraying was performed during this exposure. After the weathering test, the coated aluminum plate was heated to 90° C. for 10 minutes. The color of the sample after weathering was checked by naked eyes.

Another sample of the thermal indicating compositions prepared according to the following example 7 was coated on a 2″×5″aluminum plate. After drying at 60° C. for 5 minutes, the coated aluminum plate was subjected to WRC Weathering Method 3-12 for 748 and 2248 h. The WRC Weathering Method 3-12 was similar to the WRC Weathering Method 3-11, except that water spray was performed during this exposure. After the weathering test, the coated aluminum plate was heated to 90° C. for 10 minutes. The color of the sample after weathering was checked by naked eyes.

### Example 1

0.014 g of Solvent yellow 98 as a dye, 10 g of a polyethylene powder having a melting point between 90 and 100° C. as a latent solvent for the dye, 40 g of PKHW-34 as a binder, and 5 g of TiO₂ as a brightening agent were combined in a cup and mixed fully on a DAC Speedmixer for 1 minute at 1000 rpm to obtain a thermal indicating composition. Then, the obtained thermal indicating composition was subjected to the color changing test as described above. Then, the thermal indicating composition was coated on a PET web. Specifically, the obtained coating after drying at room temperature was nearly white. When the temperature of the sample was increased to 90° C., the coating became slight yellow, and when the temperature of the sample was increased to 110° C., the coating became very bright yellow, which shown the true color of Solvent yellow 98.

### Example 2

0.125 g of Solvent orange 63 as a dye, 100 g of Castor wax having a melting point between 80 and 87° C. as a latent solvent for the dye, 300 g of Rovene 6025 as a binder, 3.9 g of Tychem as a rheology modifier, 3 g of Tinuvin 123DW as a UV stabilizer, 3 g of Tinuvin 400DW as a UV stabilizer, and 1.5 g of ammonium hydroxide as a rheology modifier were combined in a cup and mixed fully on a DAC Speedmixer for 1 minute at 1000 rpm to obtain a thermal indicating composition. The thermal indicating composition was coated on a PET web. Then, the obtained thermal indicating composition was subjected to the color changing test as described above. Specifically, the obtained coating after drying at room temperature was nearly white. When the temperature of the sample was increased to 95° C. for 5 minutes, the coating became deep orange, which shown the true color of Solvent orange 63.

### Example 3

0.003 g of Solvent orange 63 as a dye, 60 g of Rovene 6066 as a binder, and 30 g of Castor wax having a melting point between 83 and 90° C. as a latent solvent for the dye were combined in a cup and mixed fully on a DAC Speedmixer for 1 minute at 1000 rpm to obtain a thermal indicating composition. Then the thermal indicating composition was coated on a 2″×5″aluminum plate. Then, the obtained thermal indicating composition was subjected to the color changing test as described above. Specifically, the obtained coating after drying at room temperature was nearly white. When the temperature of the sample was increased to 70° C., the coating became slight orange, and when the temperature of the sample was increased to 90° C., the coating became deep orange, which shown the true color of Solvent orange 63.

### Example 4

0.3 g of Pylakrome Magenta LX-11527 powder as a dye, 38.9 g of Carnauba wax 63 having a melting point between 83 and 90° C. as a latent solvent for the dye, 19.5 g of PKHW-35 (35% solution in water) as a binder, 2.g of polyacrylic acid (25% solution in water) as a rheology modifier, and 29.2 g of water were combined in a cup and mixed fully on a DAC Speedmixer for 1 minute at 1000 rpm to obtain a thermal indicating composition. The thermal indicating composition was coated on a PET web. Then, the obtained thermal indicating composition was subjected to the color changing test as described above. Specifically, the obtained coating after drying at room temperature was nearly white. When the temperature of the sample was increased to 130° C., the coating became peach red, which shown the true color of Pylakrome Magenta LX-11527.

### Example 5

0.011 g of Solvent orange 63 as a dye, 10 g of Vanillin having a melting point of 81-83° C. as a latent solvent for the dye, 1 g of Sodium benzoate as a nucleating agent, and 0.2 g of Thinuvin P as a UV stabilizer were combined in a cup and mixed fully on a DAC Speedmixer for 1 minute at 1000 rpm to obtain a thermal indicating composition. The thermal indicating composition was coated on a PET web. Then, the obtained thermal indicating composition was subjected to the color changing test as described above.

Specifically, the obtained coating after drying at room temperature was nearly white. When the temperature of the sample was increased to 85° C., the coating became deep orange, which shown the true color of Solvent orange 63.

### Example 6

0.011 g of Solvent orange 63 as a dye, 10 g of Vanillin having a melting point of 81-83° C. as a latent solvent for the dye, 11 g of 20% BM/IBM in cyclohexane as a binder, 1 g of Sodium benzoate as a nucleating agent, and 0.2 g of Thinuvin P as a UV stabilizer were combined in a cup and mixed fully on a DAC Speedmixer for 1 minute at 1000 rpm to obtain a thermal indicating composition. The thermal indicating composition was coated on a PET web. Then, the obtained thermal indicating composition was subjected to the color changing test as described above. Specifically, the obtained coating after drying at room temperature was nearly white. When the temperature of the sample was increased to 85° C., the coating became deep orange, which shown the true color of Solvent orange 63.

### Example 7

0.060 g of Solvent orange 63 as a dye, 60 g of Castor wax having a melting point between 80 and 87° C. as a latent solvent for the dye, 60 g of PKHW-34 as a binder, and 8 g of water were combined in a cup and mixed fully on a DAC Speedmixer for 1 minute at 1000 rpm to obtain a thermal indicating composition. The thermal indicating composition was coated on an aluminum plate.

### Comparative Example 1

0.050 g of Solvent orange 63 as a dye, 50 g of oleamide having a melting point of about 70° C. as a latent solvent for the dye, 1 g of Thinuvin P as a UV stabilizer, 1 g of Irganox 1010 as an antioxidant, and 50 g of 20% Kraton D1161 in cyclohexane as a binder were combined in a cup and mixed fully on a DAC Speedmixer for 1 minute at 1000 rpm to obtain a thermal indicating composition. Then the thermal indicating composition was coated on a 2″×5″aluminum plate. Then, the obtained thermal indicating composition was subjected to the color changing test as described above. Specifically, when the coated aluminum plate was heated to 80°V, the color of the thermal indicating composition did not change. It is presumed that because oleamide has less polar groups, it is difficult to dissolve the dye.

The thermal indicating composition prepared in the above Example 7 was further subjected to Weathering test according to the methods as described above. Specifically, the thermal indicating composition prepared in the above Example 7 was subjected to the WRC Weathering Method 3-11 and WRC Weathering Method 3-12. The obtained results indicated that the sample after being weathered according to WRC Weathering Method 3-11 and WRC Weathering Method 3-12 may be activated successfully after being weathered.

Those described above are only specific embodiments of the invention, but the scope of the invention is not limited thereto. Within the technical scope disclosed by this present invention, any person skilled in the art will easily conceive variations or replacements, which should be covered by the scope of the invention. Therefore, the protection scope of the invention should be determined by the scope of the claims.

1. A thermal indicator comprising an organic solid material having a melting point higher than ambient temperature and a dye which contacts the organic solid material, wherein the dye is in a crystalline state and wherein the dye dissolves in the organic solid material to a molecular state to show the true color of the dye's molecular state when the thermal indicator is heated to the melting point of the organic solid material.

2. The thermal indicator according to claim 1, wherein the melting point of the organic solid material is between 70° C. and 130° C.

3. The thermal indicator according to claim 1, wherein the organic solid material is colorless, white or pale yellow.

4. The thermal indicator according to claim 1, wherein the organic solid material is selected from a wax, a polymer, an organic non-polymeric material, or a mixture thereof.

5. The thermal indicator according to claim 4, wherein the organic non-polymeric material is vanillin or triphenylphosphine.

6. The thermal indicator according to claim 4, wherein the wax is selected from castor wax, carnauba wax, a synthetic wax, or a mixture thereof.

7. The thermal indicator according to claim 4, wherein the polymer is selected from polyethylene, polyurethane, other low melting temperature polymers, or a mixture thereof.

8. The thermal indicator according to claim 1, wherein the dye is selected from an anthraquinone dye, an amino ketone dye, a solvent dye, or a mixture thereof.

9-19. (canceled)

20. The thermal indicating composition according to claim 1, further comprising 0 to 80% by weight of a binder based on the total weight of the thermal indicating composition.

21. The thermal indicating composition according to claim 20, wherein the binder is selected from a butylmethacrylate/isobutylmethacrylate copolymer, a dispersion of phenoxy resin, a styrene-isoprene-styrene triblock copolymer, a polystyrene-acrylic emulsion, or a mixture thereof.

22-29. (canceled)

30. A thermal indicating structure comprising a transparent substrate, an adhesive layer, and a stripping liner laminated in turn, wherein one side of the transparent substrate facing to the adhesive layer has one or more depression portions which are filled with the thermal indicating composition comprising an organic solid material having a melting point higher than ambient temperature and a dye which contacts the organic solid material, wherein the dye is in a crystalline state and wherein the dye dissolves in the organic solid material to a molecular state to show the true color of the dye's molecular state when the thermal indicator is heated to the melting point of the organic solid material.

31-36. (canceled)

37. A thermal indicating structure comprising a transparent substrate, an organic solid layer having a melting point higher than ambient temperature, a dye layer, an isolation polymer layer, an adhesive layer, and a stripping liner laminated in turn, wherein the dye layer comprises a dye disposed in a crystalline state and wherein the dye dissolves into the organic solid layer to a molecular state to show the true color of the dye's molecular state when the thermal indicating structure is heated to the melting point of the organic solid layer.

38. The thermal indicating structure according to claim 37, wherein the melting point of the organic solid layer is between 70° C. and 130° C.

39. The thermal indicating structure according to claim 37, wherein the organic solid layer is colorless, white or pale yellow.

40. The thermal indicating structure according to claim 37, wherein the organic solid material in the organic solid layer is selected from a wax, a polymer, an organic non-polymeric material, or a mixture thereof.

41. The thermal indicating structure according to claim 40, wherein the organic non-polymeric material is vanillin or triphenylphosphine.

42. The thermal indicating structure according to claim 40, wherein the wax is selected from castor wax, carnauba wax, a synthetic wax, or a mixture thereof.

43. The thermal indicating structure according to claim 40, wherein the polymer is selected from polyethylene, polyurethane, other low melting temperature polymers, or a mixture thereof.

44. The thermal indicating structure according to claim 37, wherein the dye in the dye layer is selected from an anthraquinone dye, an amino ketone dye, a solvent dye, or a mixture thereof.

45-49. (canceled)
